(19) United States
(12) Patent Application Publication
(10) Pub. No.: US 2005/0047063 A1
(43) Pub. Date: Mar. 3, 2005

(54) Wall part of a housing for a cabinet-type household appliance

(75) Inventors: Edwin Bolduan, Berlin (DE); Horst Wiemer, Kleinmachnow (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/929,222

(22) Filed: Aug. 30, 2004

(30) Foreign Application Priority Data
Aug. 28, 2003 (DE) 103 39 741.8

(51) Int. Cl. H02B 1/00

(52) U.S. Cl. 361/600

(57) ABSTRACT

Housings for cabinet-type household appliances often have a covering panel which is fitted on the top side and which has a carrying structure of injection-molded plastic. Previously, such wall parts have no other function than that of closing off the appliance. For more efficient utilization of such wall parts, several functional parts of the household appliance are incorporated integrally in the carrying structure. The functional parts may be tray structures for a detergent or rinsing-agent dispenser or cavity structures for carrying water and air.

### BACKGROUND OF THE INVENTION

Field of the Invention

The invention pertains to household appliances and is based on an outer wall part of a housing for a cabinet-type household appliance, primarily comprising a carrying structure made of injection-molded plastic with a configuration of reinforcing ribs on the underside.

Wall parts of cabinet-type household appliances usually have the one function of closing off the interior of the appliance in order that, in particular, untrained users of the household appliance are prevented from reaching into the interior of the appliance. In addition, such a housing with its wall parts also serves for the decorative cladding of otherwise unsightly technical components.

German published patent application DE 2 312 884 A1 discloses a prior art washing machine wherein it has indeed already been proposed for a double-walled supply container, for a number of fabric-softener doses which are to be transferred in portions into a detergent dispenser in order to be dispensed individually into a tub, to be arranged with a cooling chamber, which encloses the supply container in a double wall, in the region of the covering panel of the housing. However, this only relates to subassemblies which are presented individually in each case, and are installed individually in each case, being accommodated as far away as possible from heat-emitting subassemblies. Furthermore, there may not be a sufficient amount of space available in the region of the covering panel, which itself likewise constitutes a self-contained subassembly, in order to meet the desired requirements.

### SUMMARY OF THE INVENTION

It is accordingly an object of the invention to provide a housing wall part for a cabinet-type household appliance which overcomes the above-mentioned disadvantages of the heretofore-known devices and methods of this general type and which utilizes the wall parts of the above-mentioned type more efficiently and thus minimizes the production costs of household appliances.

With the foregoing and other objects in view there is provided, in accordance with the invention, an outer wall part of a housing for a cabinet-type household appliance, comprising:
a carrying structure of injection-molded plastic;
a configuration of reinforcing ribs formed on an underside of said carrying structure; and
a plurality of functional parts of the household appliance integrally incorporated in said carrying structure.

In other words, the objects of the invention are achieved with the outer wall part that has functional parts of the household appliance incorporated integrally in the carrying structure. Advances in plastic injection-molding technology make it possible to integrate a wide variety of components which can be formed from plastic in plastic structures of wall parts. The production costs of household appliances are considerably reduced as a result.

In particular for water-carrying or water-bearing household appliances, the integration of components which serve for channeling water within the appliance is particularly advantageous. These components include tray structures for a detergent or rinsing-agent dispenser as well as cavity structures for channeling water or air.

In accordance with an added feature of the invention, parts of an operating panel of the household appliance are incorporated as the functional part.

In accordance with an additional feature of the invention, the functional parts are water-channeling parts of the household appliance.

In accordance with another feature of the invention which is especially advantageous in a washing machine or a dishwasher, the carrying structure is a covering panel which is provided for installation on the top of the housing. Preferably, the functional part is a tray structure for a detergent dispenser. In the alternative, or additionally, the functional part provided is a cavity structure for channeling water and/or air within the household appliance.

Other features which are considered as characteristic for the invention are set forth in the appended claims.

Although the invention is illustrated and described herein as embodied in a wall part of a housing for a cabinet-type household appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a front top perspective view of a washing machine;

FIG. 2 is a partially diagrammatic plan view of a housing-covering panel configured according to the invention; and

FIG. 3 is a partly broken-away, left side elevational view of the housing-covering panel according to FIG. 2.

### DESCRIPTION OF THE PREFERRED EMBODIMENTS

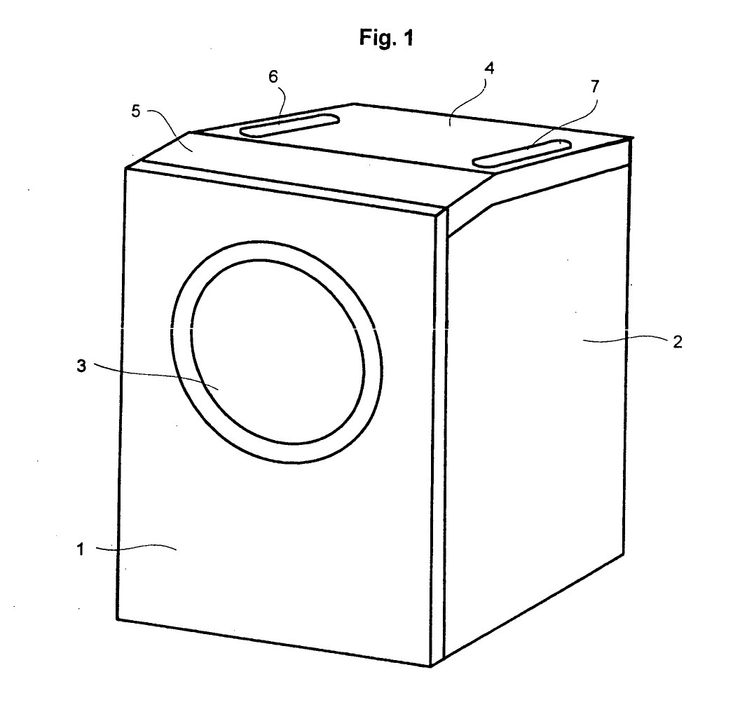

Referring now to the figures of the drawing in detail and first, particularly, to FIG. 1 thereof, there is shown a housing of an exemplary front-loading washing machine with a front wall 1, a rear wall (which is not visible) and two side walls, of which the right-hand side wall 2 is visible. The front wall 1 has a loading door 3 through which batches of laundry can be introduced and removed. Installed on the top side of the machine housing is a covering panel 4 which, on the front side, has a downwardly angled operating panel 5, which is connected integrally to the covering panel. In order to give a clearer illustration, details of how the operating panel is fitted have not been included in the present drawing. Additionally incorporated in the covering panel 4 are tray structures (which are visible in FIG. 3) for detergent dispensers, of which the cover 6 can be seen on the left-hand side and the cover 7 can be seen on the right-hand side.

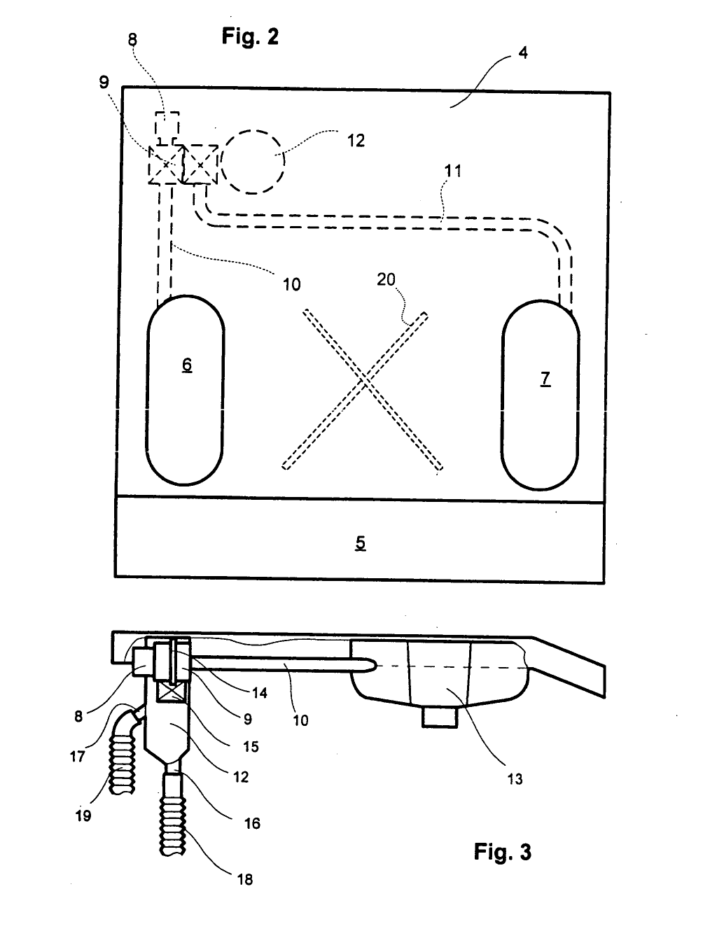

The covers 6 and 7 are also seen in the plan view of the covering panel in FIG. 2. Moreover, dashed lines are used to illustrate that a hose connection 8, a magnetic valve 9, connecting tubes 10 and 11 and a backflow tank 12—the function of the latter will be explained at a later stage in the text—are fitted on the underside of the covering panel 4. The covering panel 4, which is an injection molded plastic part, is formed with reinforcing ribs 20 on its bottom side. The reinforcing ribs 20 are integrally molded with the covering panel 4. It will be understood that the illustration of the ribs 20 is highly diagrammatic only and they will be placed and distributed according to the required technical weight-loading specifications of the device. The above-mentioned components 8, 10, 11, and 12, as well as fastening elements for the magnetic valves 9, are also integrally incorporated in the carrying structure of the covering panel 4. The carrying structure consists of injection-molded plastic. This configuration gives rise to a very cost-effective construction for the subassembly comprising covering panels and various water-channeling and air-channeling structural elements of the washing machine. The construction is rendered cost-effective, on the one hand, as a result of joint production and, on the other hand, as a result of a considerably smaller number of installation steps.

The side view illustrated in FIG. 3, wherein the left-hand flank surface of the covering panel 4 is illustrated in partly broken-away form in order to give a better view of the structural elements incorporated, clearly shows the left-hand tray structures 13 of the detergent dispenser fitted underneath the cover 6. The latter is hinge-mounted, for example, in the carrying structure. The feed tube 10 leading to it connects the tray structure 13 to the magnetic valve 9, which is connected to the carrying structure by way of an integrally molded fastening element 14. The feed tube 11 for the other tray structure beneath the cover 7 is not visible behind the feed tube 10.

The feed tube 10 is connected to the magnetic valve 9, which is retained by means of a fastening element 14 integrally formed on the carrying structure of the covering panel 4. The magnetic valve 9 is controlled by an actuating magnet 15 which is connected to a non-illustrated control device of the washing machine. The inlet to the magnetic valve 9 is defined by a connection fitting 8, to which it is possible to connect an external inflow hose.

Behind the magnetic valve 9, a backflow tank 12 is integrally molded on the carrying structure. The backflow container has an inlet connector 16 at the bottom end and an outlet connector 17 integrally molded on it approximately half way up. Connected to these connectors are the pump hose 18, for discharging the detergent solution from the tub (not illustrated) of the washing machine, and the drainage hose 19, by means of which the detergent solution delivered into the backflow tank 12 is directed into a collecting device (discharge or the like) located outside the washing machine.

The backflow tank 12 serves, on the one hand, for separating out solid foreign bodies from the pumped-out detergent solution and, on the other hand, for providing at a level above the drainage opening of the tub, a washing volume which, when the detergent-solution pump is switched off, enhances the closing force of a non-return valve which closes the drainage opening.

Above the outlet connector 17, the backflow tank 12 contains an air space which is connected to the outside air for the purpose of ventilating the drainage path. It is thus possible to avoid the situation where, when the draining-off detergent solution exceeds the high level in the backflow tank 12 and, at the same time, the detergent-solution pump is switched off, the residual detergent solution is nevertheless extracted from the tub by siphon action.

Instead of a second detergent dispenser beneath the cover 7, however, supplies of detergent in a dry state may also be accommodated there. It is then possible for individual portions to be transferred manually from these supplies into the detergent dispenser fitted on the left-hand side beneath the cover 6. In that case, the cavity structure (feed tube 11) at this location would not be necessary.

This application claims the priority, under 35 U.S.C. § 119, of German patent application No. 103 39 741.8, fired Aug. 28, 2003; the entire disclosure of the prior application is herewith incorporated by reference.

1. An outer wall part of a housing for a cabinet-type household appliance, comprising:
a carrying structure of injection-molded plastic;
a configuration of reinforcing ribs formed on an underside of said carrying structure; and
a plurality of functional parts of the household appliance integrally incorporated in said carrying structure.

2. The wall part according to claim 1, which further comprises an operating panel of the household appliance, said operating panel having parts thereof incorporated as at least one of said functional parts.

3. The wall part according to claim 1, wherein the household appliance is a water-carrying household appliance, and said functional parts are water-carrying parts of the household appliance.

4. The wall part according to claim 3 configured for a washing machine or a dishwasher, wherein said carrying structure is a covering panel for installation on top of a housing of the appliance.

5. The wall part according to claim 4, wherein said functional parts include a tray structure for a detergent dispenser integrally molded in said covering panel.

6. The wall part according to claim 4, wherein said functional parts include a cavity structure for channeling water within the household appliance.

7. The wall part according to claim 4, wherein said functional parts include a cavity structure for channeling air within the household appliance.
